(19) United States
(12) Patent Application Publication
(10) Pub. No.: US 2025/0178296 A1
(43) Pub. Date: Jun. 5, 2025

(54) METHODS AND MATERIALS FOR MODULATING CONSTRUCT WEAR DUE TO CYCLIC LOADING

(71) Applicant: Arizona Board of Regents on Behalf of The University of Arizona, Tucson, AZ (US)

(72) Inventors: Marvin J. Slepian, Tucson, AZ (US); Syed Hossainy, Tucson, AZ (US)

(21) Appl. No.: 18/843,251

(22) PCT Filed: Mar. 1, 2023
(86) PCT No.: PCT/US2023/063463

§ 371 Date: Sep. 1, 2024

Related U.S. Application Data
(60) Provisional application No. 63/315,320, filed on Mar. 1, 2022.

(51) Int. Cl. B29C 70/54; B29C 51/12; B29C 51/42; B29C 70/56; B29K 1/00; B29K 71/00; B29K 75/00

(52) U.S. Cl. CPC B29C 70/543; B29C 51/12; B29C 51/426; B29C 70/56; B29K 2001/08; B29K 2071/00; B29K 2075/00

(57) ABSTRACT

The methods described herein can be used to produce constructs that are stronger and more resilient when subjected to repeated cyclic loading. The constructs can be formed by fabricating the construct in its mid-point conformation, and then repositioning the construct in its deployment conformation. Alternatively or additionally, the constructs can be formed with additional polymeric material and/or metals added in particular locations that correspond with the pattern of principal stress distribution when the construct is in use. Alternatively or additionally, the constructs can be formed with a plurality of fibers or metal particles embedded therein, where the fibers/particles are oriented in the direction(s) of major load(s) that are applied to the construct during use. Also described are constructs formed by the methods described above. The constructs are used in devices, medical implants, plastic flaps, tubing and/or pipes, and/or the wings of an airplane that are subjected to repeated cyclic loading.

### CROSS-REFERENCE TO RELATED APPLICATION

This application claims benefit and priority to U.S. Application No. 63/315,320, filed Mar. 1, 2022, the disclosure of which is incorporated herein by reference.

### FIELD OF THE INVENTION

The disclosed invention is generally in the field of constructs made from polymeric materials, polymer composites, metallic materials, and polymer-metal composites that are subjected to cyclic loading in use.

### BACKGROUND OF THE INVENTION

Materials are utilized to fabricate a wide range of objects, articles, items, implements, instruments and devices, which are herein themed “constructs.” Constructs are utilized in broad application areas. Application areas for these material constructs include: medical and healthcare, industrial and manufacturing, civic and public works, recreation and sports and other diverse sectors.

Many of these material constructs are fabricated from polymeric materials, polymer composites, metallic materials and polymer-metal composites and undergo cyclic load during their duty cycle of intended use. Over time this leads to cumulative effects which lead to progressive/additive fatigue and net wear.

Therefore, there is a need for improved methods for making constructs that are subjected to cyclic loading in use.

There is also a need for stronger and more durable constructs.

It is an object of the invention to provide improved methods for making constructs that are subjected to cyclic loading in use.

It is a further object of the invention to provide improved constructs that are better able to withstand repeated cyclic loading during use.

### SUMMARY OF THE INVENTION

The methods described herein can be used to produce constructs that are stronger and more resilient when subjected to repeated cyclic loading. The constructs can be formed by fabricating the construct in its mid-point conformation, and then repositioning the construct in its deployment conformation. Alternatively or additionally, the constructs can be formed with additional polymeric material and/or metals added in particular locations that correspond with the pattern of principal stress distribution when the construct is in use. Alternatively or additionally, the constructs can be formed with a plurality of fibers or metal particles embedded therein, where the fibers/particles are oriented in the direction(s) of major load(s) that are applied to the construct during use.

Also described are constructs formed by the methods described above. The constructs are used in devices, medical implants, plastic flaps, tubing and/or pipes, and/or the wings of an airplane that are subjected to repeated cyclic loading.

The constructs contain one or more base polymers. Suitable base polymers include thermoplastics and thermosets. Optionally, the constructs include one or more bulking polymers in one or more bulking region(s), one or more fibers that are oriented in the direction(s) of the major load(s) that are applied to the construct during repeated use.

### BRIEF DESCRIPTION OF THE DRAWINGS

The accompanying drawings illustrate several embodiments of the disclosed method and compositions and together with the description, serve to explain the principles of the disclosed method and compositions.

FIGS. 1A, 1 B and 1C depict an exemplary use cycle for a construct 100 which is fixed at one end, its fixture point 110, and able to bend and move 1800 at its opposite end. During the typical use cycle, the construct bends from 0° to 180°. FIG. 1A shows the construct at its mid-point conformation (i.e. 90°). FIG. 1B shows the construct bending to assume a conformation at about 180°. FIG. 1C shows the construct bending during use and approaching the 0° conformation.

FIGS. 2A, 2B and 2C depict two steps of a method for forming a construct in its mid-point conformation and then repositioning it into a second conformation, which corresponds with its deployment conformation. FIG. 2A shows the construct at its mid-point conformation (i.e. 90°) during the fabrication step which forms the construct. FIG. 2B shows the construct in its midpoint conformation and undergoing additional thermoforming or further processing in this conformation. FIG. 2C shows the construct repositioned into its deployment conformation, i.e. 1800 conformation.

FIGS. 3A and 3B are illustrations of an exemplary construct 200 that contains one or more bulking regions (210a, b, c) attached to or integrated in the surface 220.

FIGS. 4A and 4B are illustrations of an exemplary construct 200′ that contains a plurality of bulking regions 210a′,b′, and c′. As stress is applied to different portions of the construct during use, the bulking material in the bulking regions can redistribute from a first position (depicted in FIG. 4A) to a second position (depicted in FIG. 4B), where the bulking regions 210a′ and 210b′ are redistributed to the regions of high stress 230a′ and 230b′.

FIGS. 5A and 5B are illustrations of an exemplary construct 300 without (FIG. 5A) and with (FIG. 5B) bulking regions in the regions of high stress 330a and 330b during a cycle of use in which the construct bends at regions 330a and 330b. As shown in FIG. 5B, the regions of high stress 330a′ and 330b′ with the bulking regions 310a′ and 310b′ attached thereto are thicker than the surrounding regions of the construct 300′.

FIGS. 6A-6C are illustrations of an exemplary construct containing a plurality of fibers embedded in the polymeric material. FIG. 6A shows typical random positioning of a plurality of fibers in the construct post fabrication of the construct (400). FIG. 6B shows how a plurality of fibers (see fibers 440a and 440b) can be oriented post-fabrication in a uni-directional orientation. FIG. 6C shows how the fibers in the construct can be oriented in two different directions (i.e. x-y directions).

### DETAILED DESCRIPTION OF THE INVENTION

The disclosed methods and constructs may be understood more readily by reference to the following detailed description of particular embodiments and to the Figures and their previous and following description.

It is also to be understood that the terminology used herein is for the purpose of describing particular embodiments only and is not intended to be limiting.

### I. Methods of Making Constructs

The methods described herein can be used to produce constructs that are stronger and more resilient when subjected to repeated cyclic loading compared to the same constructs made using prior methods.

In some embodiments, the constructs are formed via a method containing at least the following steps:
(i) determining the mid-point conformation of the construct when subjected to repeated loading over a cycle of use,
(ii) fabricating the construct in the mid-point conformation, optionally wherein the construct comprises a base polymer, and
(iii) subsequent to step (ii), repositioning the construct into a second conformation that is different from the mid-point conformation, optionally wherein the second conformation is in its deployment conformation.

Alternatively or additionally, the constructs can be formed with additional polymeric material and/or metals added to the construct in particular locations that correspond with the pattern of principal stress distribution when the construct is in use.

Alternatively or additionally, the constructs can be formed with a plurality of fibers embedded therein, where the fibers are oriented in the direction(s) of the major load(s) that are applied to the construct during repeated use.

### A. Method for Forming Constructs in the Mid-Point Conformation

In a first exemplary method, the constructs are fabricated in their mid-point conformation. When a polymeric construct is formed, molded or otherwise fabricated in a mid-cycle position of a loading cycle, its intrinsic stress would be set at a point, e.g., a midpoint, reducing the net accumulated stress when used over time.

The construct can also be subjected to elevated temperature to relieve residual stress while subjecting the construct to small forces to place the construct in its deployment conformation. A construct's deployment conformation corresponds with the conformation of the construct when it begins a use cycle. For example, for an implantable device, the deployment conformation refers to the position the device is in when it is fully implanted in a patient's body at the desired site.

This stepwise thermoforming, while deforming the construct, reduces the overall residual stress and effect of cyclic strain on the construct over time. The resulting construct has less fatigue failure compared to the same construct formed at another position within the range of positions the construct assumes during a typical cycle of use.

The first exemplary method includes at least the following steps:
(i) determining the mid-point conformation of the construct when subjected to repeated loading over a cycle of use,
(ii) fabricating the construct in the mid-point conformation, optionally wherein the construct comprises a base polymer, and
(iii) subsequent to step (ii), repositioning the construct into a second conformation that is different from the mid-point conformation, optionally wherein the second conformation is in its deployment conformation.
   1. Determining the Mid-Point Conformation of the Construct when Subjected to Repeated Loading Over a Cycle of Use

In the first step, a construct or model thereof is formed and moved through a typical use cycle to determine or estimate the locations and relative amounts, e.g. high versus low, of stress in each location throughout a typical use cycle for all or one or more regions within the construct. The regions of the construct in which the relative amounts of stress will be analyzed correspond with the regions in which bending, twisting, stretching, or other motions occur and the regions adjacent thereto. During this step, the midpoint within these regions is determined and/or estimated and the conformation of the construct or a model thereof is determined. This conformation is the mid-point conformation for the construct.

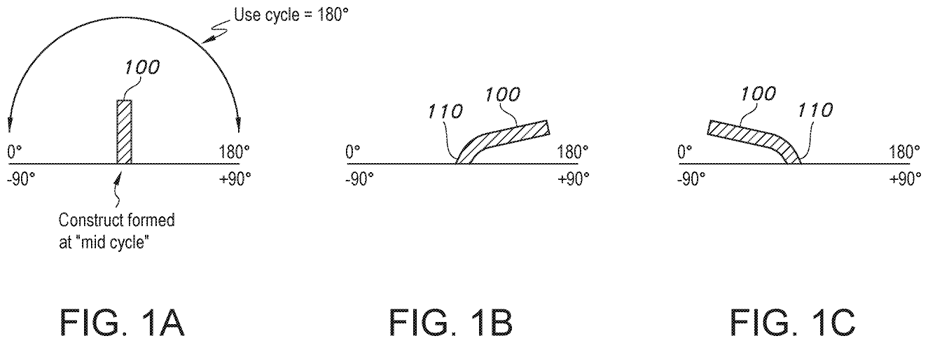

For example, as illustrated in FIGS. 1A, 1B and 1C, if a flap undergoes 180° of strain, the mid-point conformation corresponds with the conformation of the flap at 90° (see FIG. 1A). When the flap is fabricated at its midpoint conformation, then the net flexure is 90° in one direction followed by 90° in the other direction (see FIGS. 1B and 1C). Over time at the hinge point 110, fixture point or other stress accumulator location, the additive stress is reduced, leading to reduced fatigue and/or delaying the time period to failure, compared to a construct fabricated from the same polymeric materials but in a different conformation than the 90° conformation and subjected during use to 180° of strain.

Similarly, in a polymeric heart valve, the movement of the leaflets during a complete cycle, including systole and diastole, can be modeled to determine the mid-point conformation of the leaflets. The mid-point conformation is a semi-open conformation. The semi-open leaflet conformation aids in minimizing both overall stresses in the valve and during formation of the valve in molding. Further, a semi-open profile can lower the stresses in the polymeric leaflets during systole, i.e. when the valve's leaflets are fully open, as well as lowering the typical increased stresses acting on the closed leaflets during diastole.

Step (i) can include modeling the construct and subjecting the model to a load through the range of motion of the construct or a portion thereof during one or more use cycles, and estimating the spatially dependent stresses in at least one region of the construct, optionally throughout the construct.

A model of the construct can refer to a physical model formed from a material that is the same as or different from the material of the final construct. Optionally the model is a digital model, such as one created using software, which can be digitally manipulated to determine or estimate the midpoint conformation of the model during a typical cycle of use and optionally, to determine or estimate the spatially dependent stresses in one or more regions of the construct, optionally throughout the construct, during a typical cycle of use.

### 2. Fabricating the Construct in the Mid-Point Conformation

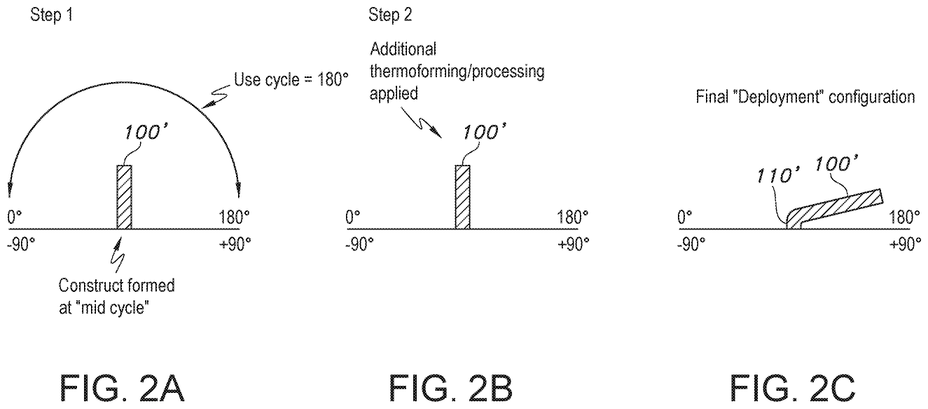

Next, a construct is formed such that the construct is in its midpoint conformation (see, e.g. FIGS. 1A and 2A). During step (ii), the construct is fabricated via thermoforming, by heating a base polymer to a suitable temperature in which the polymer softens allowing the polymeric material to be stretched and pushed into a desired first confirmation. Optionally, the base polymer is heated until it is flowable so that it can be fed into a mold, where the mold has a suitable configuration for the polymer to be pressed against the mold, and/or between the positive and negative mold portions, to form the construct at its midpoint conformation.

Suitable thermoforming processes include but are not limited to vacuum thermoforming, pressure thermoforming, and mechanical thermoforming.

Suitable molding processes include compression molding, tension molding, injection molding, and/or extrusion molding.

a. Base Polymers

Suitable base polymers include thermoplastic and thermoset polymers.

Exemplary polymers which can be used to form the construct include thermoplastic polymers/elastomers, thermoset polymers, thermally crosslinkable polymers, elastomeric polymer biomaterials, polymers containing polysulfone(s), polyurethanes, silicones, PTFE, crosslinked poly(styrene-isobutylenese-styrene) (xSIBS), and poly(styrene-isobutylene-styrene) (SIBS).

Suitable thermoplastic elastomers (TPEs) can be formed of or contain polymyrcene, polymenthide, and poly(F-decalactone), and blends and copolymers thereof. Suitable elastomeric biomaterials can include, for example, silicones, thermoplastic elastomers, polyolefins, polydiene elastomers, poly(vinyl chloride), natural rubbers, heparinized polymers, hydrogels, polypeptides elastomers, polysiloxane-urea elastomers, and polyurethanes, such as Elast-Eon® (AorTech International, polyurethanes with a hard segment content and a mixed polyether/siloxane soft segment), and blends and copolymers thereof.

Additional suitable polymers include thermoplastic polymers, such as acrylics, acrylonitrile butadiene styrene (ABS), polyamides (such as nylon), polybenzimidazole, polycarbonate, polyether sulfone, polyoxymethylene, polyether ether ketone, polyaryletherketone (PAEK), polyetherimide, polyethylene, polyphenylene oxide, polyphenylene sulfide, polypropylene, polystyrene, polyvinylidene fluoride, polyvinylsulfone (PVS), poly ethylene vinyl alcohol (EVAL), and polyacrylonitrile (PAN), and blends and copolymers thereof. Suitable thermoplastic polymers for medical device applications include segmented polyurethanes (SPU), polyetheleneterpetahlate (PET, such as Dacron), polypropylene, polyvinylidene fluoride (PVDF), etc.

Optionally the polymer is a thermosetting polymer, such as for example, an epoxy, silicone, polyurethane, thermosetting polyimide, cyanate ester, thermosetting polyester, unsaturated polyester, vinyl ester, epoxy functionalized polymers, crosslinked poly(styrene-isobutylenese-styrene) (xSIBS), and poly(styrene-isobutylene-styrene) (SIBS), silicone, or phenolic.

Suitable low Tg rubber-like thermoset polymers include but are not limited to vulcanized rubbers, silicone rubber, natural rubber (NR), amorphous ethylene-propylene-diene rubber (EPDM) (e.g. EPG 3440), chloroprene rubber (CR), acrylonitrile-butadiene rubber (ABR), emulsion-polymerized styrene-butadiene rubber (E-SBR), polymerized in solution styrene-butadiene rubber (L-SBR).

Tg and Δcₚ values obtained using the ASTM method from DSC curves are summarized in Table 1 below.

TABLE 1
Tg for Exemplary Rubber-like thermoset polymers

| Polymer | T_{g} in ° C. | Δcₚ in J/gK |
|---|---|---|
| Silicone rubber | −123 | 0.32 |
| NR | −62 | 0.46 |
| EPDM | −53 | 0.43 |
| CR | −37 | 0.33 |
| E-SBR | −50 | 0.54 |
| NBR | −32 | 0.50 |
| L-SBR | −20 | 0.45 |

Optionally, the base polymer is a bioabsorbable polymer, such as polylactide (PLA), polycaprolactone (PCL) poly(valerolactone) (PVL), polyhyhdroxyalkanoate (PHA).

Optionally the base polymer is paste-extruded or formed similar to powder processing, such as polytetrafluoroethylene (such as Teflon).

As appropriate, the skilled person would be able to select conditions (i.e., temperatures, solvent(s), etc.) needed to form polymer feed, polymer sheets, polymer melts, or polymer solutions of the aforementioned to be able to form the constructs.

3. Repositioning the Construct into a Second Conformation that is Different from the Mid-Point Conformation

Following the formation of the construct in its midpoint conformation, the construct is repositioned into a second conformation that is different from the midpoint conformation. Typically, the second conformation corresponds with the deployment conformation for the construct or a portion thereof. The deployment conformation refers to the position where the moveable region(s) of the construct or all of the construct is in when the construct is initially used. For example, if the construct is implanted in a patient's body, the deployment conformation refers to the position of the construct following implantation. For example, if the construct is an implantable polymeric heart valve, the leaflets of the valve are fabricated in their midpoint position, i.e. partially open position, and then repositioned to the deployment conformation, which generally corresponds with the leaflets in a closed, partially overlapping conformation.

Step (iii) includes repositioning the construct into its deployment conformation.

As shown in FIG. 2A, the construct 100′ is fabricated in step (ii) at its mid-point conformation. Subsequently, the construct is repositioned, by bending it along its fixture point 110′ into its deployment conformation, which corresponds with moving the free end of the construct approximately 90°, so that the construct is in its approximately 180° conformation. Optionally, an additional force is applied to the construct or relevant region thereof in the form of heat and/or positive or negative pressure (e.g., mechanical force, increased pressure in a pressurized vessel, or applying a vacuum). This step can involve a thermoforming process, such as vacuum thermoforming, pressure thermoforming, and/or mechanical thermoforming.

Optionally, the construct is removed from the mold used in step (ii) and placed in contact with a second mold or surface configured to align the construct or region thereof in the second conformation. Simultaneous with or subsequent to repositioning the construct into its second, deployment conformation, an additional force is applied to the construct or relevant region thereof in the form of heat and/or positive or negative pressure (e.g., mechanical force, increased pressure in a pressurized vessel, or applying a vacuum). Step (iii) can involve a thermoforming process, such as vacuum thermoforming, pressure thermoforming, and/or mechanical thermoforming.

Optionally during step (iii), the construct or a portion thereof is heated to a sufficient temperature to make the polymer deformable to the second conformation. For example, if the base polymer has a Tg at or greater than room temperature, such as for example thermoplastic polymers, the construct or relevant region thereof is typically heated to a temperature within ±5-20° C. of the Tg of the base polymer. If the base polymer has a low Tg, such as below room temperature (for example, a rubber-like thermoset polymer), the construct or relevant region thereof is heated to a temperature in the range of 25-52° C.

During step (iii), the construct may be inserted into a second mold or positioning device which is configured to set the construct in the deployment conformation. Following heating and/or applying positive or negative pressure to the construct, the construct is optionally cooled, allowing it to set in the deployment conformation.

For example, if a flap undergoes 1800 of strain, the mid-point conformation corresponds with the conformation of the flap at 900 (see, e,g., FIG. 1A), while the deployment conformation is typically when the flap is at approximately 180°, such as illustrated in FIG. 1B or at approximately 0°, such as illustrated in FIG. 1C.

Similarly, in a polymeric heart valve, the mid-point conformation is a semi-open conformation, while the deployment conformation is typically when the leaflets are closed, such that at least the distal end of each leaflet abuts the distal ends of the other leaflets in the valve.

### 4. Optional Steps

a. Applying Additional Polymeric Material or Metals to Increase the Thickness of Locations of High Stress During Use

In some embodiments, the constructs are formed with additional polymeric material and/or metals added to the construct in particular locations that correspond with the pattern of principal stress distribution when the construct is in use. In these embodiments, as part of step (i) above or as an additional step, the time-dependent principal stress distribution of a model of the construct over the duration of a cycle of use is mapped prior to step (ii). In addition to step (ii), fabricating the construct, the method includes during step (ii) or subsequent to step (ii), spatially distributing a bulking polymer or metal in a pattern that follows the regions of principal stress distribution, such that in regions of high stress during use, the construct is thicker than in regions of low stress during use.

b. Including Fibers in the Polymeric Material Used to Form the Construct

In addition to or as an alternative option to the above-described step for increasing the thickness of the construct in particular regions of high stress, during step (ii) the construct can be formed with fibers to increase the strength of the materials by fiber orientation in the direction of the major load.

In these embodiments, the feed comprises a base polymer and a plurality of fibers. Following formation of the construct, an extension force is applied to one or more regions of the construct, typically to gripping regions located on one or more outer surfaces of the construct, while the construct is under tension. Optionally, during this step, the construct is heated. Optionally, the construct is subsequently subjected to one or more freeze-thaw cycles.

B. Forming the Constructs with Additional Polymeric Material and/or Metals Added to the Construct in Particular Locations that Correspond with the Pattern of Principal Stress Distribution when the Construct is in Use

In some embodiments, the constructs are formed with additional polymeric material and/or metals added to the construct in particular locations that correspond with the pattern of principal stress distribution when the construct is in use.

This method purposely shifts the neutral real axis for the construct or region thereof over a certain duration during use. By depositing additional polymeric material and/or metal at particular locations of principal stress distribution during use, the average stress on any given axis of the construct is less over the same duration, compared with the same construct having a fixed, non-shifting neutral axis. Thus, the resulting construct is more fatigue resilient than the same construct that does not contain the additional polymeric material and/or metal at these locations. The cross-section of the resulting construct changes shape gradually over repeated use over time with reduced, optionally minimal, performance loss and dimensional instability. The shape change can be reversible and cyclic such that the neutral axis shift is also cyclic.

In these embodiments, the constructs are typically formed via a method containing at least the following steps:
(i) mapping the time-dependent principal stress distribution of a model of the construct over the duration of a cycle of use,
(ii) fabricating the construct, wherein the construct comprises a base polymer, and
(iii) spatially distributing a bulking polymer or metal in a pattern that follows the regions of principal stress distribution, such that in regions of high stress during use, the construct is thicker than in regions of low stress during use.

Optionally step (iii) occurs simultaneous with step (ii). Optionally, step (iii) occurs subsequent to step (ii).

Optionally, the bulking polymer (or polymers) has a high Poisson ratio. Exemplary bulking polymers include SIBS.

Following step (iii), the resulting construct contains bulking polymer and/or metal at the high-stress spatial locations of the construct. A cross-sectional change over time and repeated use cycles, can occur within the construct due to greater toughness and/or small plastic deformation in the direction orthogonal to the load experienced during a use cycle. Toughness refers to the ability of the construct to absorb energy and plastically deform without fracturing and can be measured by dynamic mechanical analysis (DMA), nanoindentation, DSC, etc.

### 1. Mapping the Time-Dependent Principal Stress Distribution of a Model of the Construct Over the Duration of a Cycle of Use

In the first step, a construct or model thereof is formed and moved through a typical use cycle to determine or estimate the locations and relative amounts, e.g., high versus low, of stress in each location throughout a typical use cycle for all or one or more regions within the construct. The construct or a model thereof is mapped, with particular attention to regions of strain or stress, and/or the surrounding regions thereof. The regions of the construct in which the relative amounts of stress are analyzed generally correspond with the regions in which bending, twisting, stretching, or other motions occur and the surrounding regions thereof.

2. Fabricating the Construct Next, a construct is formed. During step (ii), the construct is fabricated via thermoforming using any of the methods described above with respect to step (ii) of Section A.

The base polymer can be any of the polymers described above in Section A, as well.

3. Spatially Distributing a Bulking Polymer or Metal in a Pattern that Follows the Regions of Principal Stress Distribution,

Step (iii) involves spatially distributing a bulking polymer or metal in a pattern that follows the regions of principal stress distribution, such that in regions of high stress during use, the construct is thicker than in regions of low stress during use.

Following step (iii), when the construct is subjected to the repeated cyclic loading in use, the neutral axis of the construct shifts compared to its location when the construct is formed in the absence of step (iii). For example, the neutral axis can shift by about 1% or more, 5% or more 10%, or more following repeated use, such as greater than 10 cycles of use, greater than 100 cycles of use, greater than 500 cycles of use, greater than 1000 cycles of use.

a. Bulking Polymer

The bulking polymer is a polymer that distributes under stress within the construct following repeated cycles of use, thereby reducing the stress at a given location compared to the stress at that same location in the absence of the bulking polymer.

The bulking material may be the same as the base material in the construct. Optionally, the bulking material is different from the base material in terms of molecular weight, crystallinity, and/or chemical structure. Optionally, the bulking material is a composite including the base polymer of the construct. The use of the same material or a composite containing the base polymer of the construct results in a smooth transition from the region of the construct that surrounds the bulking region. Providing a smooth transition from one region to the next, rather than a sharp discontinuity, prevents or reduces the likelihood of the bulking region(s) creating a fracture point in the construct.

The bulking polymer typically has a high Poisson ratio, optionally the bulking polymer is a thermoplastic polymer, such as an elastomer. Optionally, the bulking polymer forms a polymeric material with a Poisson ratio of at least greater than 0, optionally greater than 0.15, and/or in the range of 0.15 to 0.5, 0.2 to 0.5, or 0.3 to 0.5.

Suitable bulking polymers that can be applied to the construct either at the same time of formation of the construct or after the construct is formed include, but are not limited to polyurethanes (PU), polypropylene (PP), polyacrylonitrile (PAN), polyethylene terephthalate (PET), and polyetheretherketone (PEEK).

In some embodiments, the bulking polymer is the same as the base polymer. Optionally, the bulking polymer is different than the base polymer.

Simultaneous with step (ii), one or more bulking polymers can be applied to the construct as it forms, particularly in the locations that are subjected to high stress during use, via any suitable method. Suitable methods include molding processes, where the mold is configured to receive additional polymer, creating a thicker construct in the locations that are subjected to high stress during use. Optionally, one or more bulking polymers are melt applied, spray applied, sputtered, thermoformed, and/or applied via melt fusing, or via the use of one or more adhesives.

After the construct is formed, during step (iii), one or more bulking polymers can be applied to the construct, particularly in the locations that are subjected to high stress during use, via any suitable method. Suitable methods include melt application, spray application sputtering, thermoforming, and/or application via melt fusing, or via the use of one or more adhesives.

b. Metal

Suitable metals that can be applied to the construct either at the same time of formation of the construct or after the construct is formed include, but are not limited to gold, tantalum, platinum, palladium, lead, chromium, iron, nickel, or salts, composites, admixtures, blends or alloys of one or more of the listed metals. For example, suitable alloys of the listed metals include ferrous alloys, such as stainless steel (i.e. an alloy of iron and chromium, optionally or other metals). Optionally, the metal is radiopaque, such as gold, tantalum, platinum-iridium, and palladium. This is particularly useful for constructs that are implantable in a patient.

After the construct is formed, during step (iii), one or more metals can be applied to the construct, particularly in the locations that are subjected to high stress during use, via any suitable method. Suitable metallization methods include a cold-spray process, physical vapor deposition (PVD), chemical vapor deposition (CVD) electroplating, electroless plating, thermal spray (TS), and slurry dip coating the construct.

Optionally, during step (ii), metal fragments, particles, or other granular elements are mixed into the polymer melt to form a composite that is used to form the construct. Optionally these metal fragments, particles, or other granular elements can be used in place of fibers. Optionally a plurality of metal fragments, particles, or other granular elements are mixed into the base polymer during granulation and subsequently included in the feed to thermoform or mold the construct. Optionally, a plurality of metal fragments, particles, or other granular elements are added during an initial base polymer melt or solution forming.

C. Forming the Constructs with Fibers to Increase the Strength of the Materials by Fiber Orientation in the Direction of the Major Load

In some embodiments, the construct is formed with fibers to increase the strength of the materials by fiber orientation in the direction of the major load. In these embodiments, the constructs are typically formed via a method involving molding or thermoforming, and wherein the feed comprises a base polymer and a plurality of fibers. Following formation of the construct, an extension force is applied to one or more regions of the construct, typically to gripping regions located on one or more outer surfaces of the construct, while the construct is under tension. Optionally, during this step, the construct is heated. Optionally, the construct is subsequently subjected to one or more freeze-thaw cycles.

In these embodiments, the constructs are typically formed via a method containing at least the following steps:
(i) mapping or estimating the time-dependent principal stress distribution of a model of the construct over the duration of a cycle of use;
(ii) fabricating the construct, wherein the construct comprises a base polymer and a plurality of fibers, and
(iii) applying an extension force to one or more gripping regions on the surface of the construct, to orient the fibers in one or more directions.

### 1. Mapping the Time-Dependent Principal Stress Distribution of a Model of the Construct Over the Duration of a Cycle of Use

In the first step, a construct or model thereof is formed and moved through a typical use cycle to determine or estimate the locations and relative amounts, e.g., high versus low, of stress in each location throughout a typical use cycle for all or one or more regions within the construct. The construct or a model thereof is mapped, with particular attention to regions of strain or stress, and/or the surrounding regions thereof. The regions of the construct in which the relative amounts of stress are analyzed generally correspond with the regions in which bending, twisting, stretching, or other motions occur and the surrounding regions thereof.

### 2. Fabricating the Construct

In step (ii), a construct is formed. During step (ii), the feed contains the base polymer and a plurality of fibers. The construct is fabricated via thermoforming using any of the methods described above with respect to step (ii) of Section A.

The base polymer can be any of the polymers described above in Section A, as well.

The fibers can be any suitable fiber that can provide strength to the construct. For example, suitable fibers include cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.

The construct formed in step (ii) contains one or more gripping regions on the surface of the construct. The gripping regions may be sacrificial gripping regions, which are removed prior to use of the construct. Alternatively, the gripping regions may be part of the outer surface of the construct and remain on the construct during use.

### 3. Applying an Extension Force to One or More Gripping Regions on the Surface of the Construct, to Orient the Fibers in One or More Directions

Step (iii) includes applying an extension force to one or more gripping regions on the surface of the construct to orient the fibers in one or more directions. The extension force is applied while the construct is secured in place at the opposite end. Optionally a force is applied to the construct or one or more regions thereof that are subjected to high levels of stress during repeated use. The resulting constructs with oriented fibers are stronger than the same constructs without fibers or even than constructs containing fibers that are not oriented in the direction of the major load.

Generally, subsequent to step (ii), the construct is cured prior to applying an extension force in step (iii).

Optionally, simultaneous with applying the extension force the construct is heated to a sufficient temperature to make the polymer deformable. For example, if the base polymer is a thermoplastic, the construct or relevant region thereof is typically heated to a temperature within ±(5-20) ° C. of the Tg of the base polymer. Optionally, if the base polymer has a Tg at or greater than room temperature, such as for example thermoplastic polymers, the construct or relevant region thereof is typically heated to a temperature within ±(5-20) ° C. of the Tg of the base polymer. If the base polymer has a low Tg, such as below room temperature (for example, a rubber-like thermoset polymer), the construct or relevant region thereof is heated to a temperature in the range of 25-52° C.

As an alternative to practicing step (iii), a directional force is applied by directional ultrasound or another non-contact force field application. In these embodiments, optionally the construct does not contain one or more gripping regions.

Optionally, an extension force is bi-axially applied to the construct or a portion thereof. For example, following curing, compressed, heated air or inert gases is blown onto the construct or a portion thereof, while the construct or a portion thereof is constrained in a slightly expandible encasing.

### 4. Optional Additional Steps

Optionally, following step (iii), the construct is subjected to one or more freeze-thaw temperature cycles. For example, if the base polymer is thermoplastic, a freeze-thaw cyclic temperature scheme can be employed to orient the fibers without significantly altering the base polymer structure.

In embodiments in which the final construct does not contain one or more of the gripping regions, following step (iii), and optionally following any additional steps to orient the fibers in the construct, the sacrificial gripping regions are removed. The sacrificial gripping ends can be sawed off by laser ablation or other dislocating techniques.

### II. Constructs

A variety of different types of constructs can be formed using one or more of the methods described herein. Construct is a broad term that refers to a wide range of objects, articles, items, implements, instruments, and devices. Constructs formed by the methods described herein can be utilized in a variety of different fields, such as medical and healthcare, industrial and manufacturing, civic and public works, recreation and sports and other diverse sectors.

The methods described herein can be used to form devices, medical implants, such as polymeric valve leaflets, artificial heart diaphragm, vascular grafts, stents, AV-fistula. In other embodiments, the methods described herein can be used to form plastic flaps, such as mud flaps placed on trucks and cars, tubing and/or pipes subjected to repeated flexure, or the wings of an airplane or other flying vehicle.

The disclosed methods and constructs can be further understood through the following numbered paragraphs.

1. A method for making constructs that are subjected to repeated cyclic loading in use, comprising:
(i) determining the mid-point conformation of the construct when subjected to repeated loading over a cycle of use,
(ii) fabricating the construct in the mid-point conformation, optionally wherein the construct comprises a base polymer, and
(iii) subsequent to step (ii), repositioning the construct into a second conformation that is different from the mid-point conformation, optionally wherein the second conformation is the deployment conformation.
   2. The method of paragraph 1, wherein step (i) comprises modeling the construct and subjecting the model to a load through the range of motion of the construct or a portion thereof during one or more use cycles, and estimating the spatially dependent stresses in at least one region of the construct, optionally throughout the construct.
   3. The method of paragraph 1 or paragraph 2, wherein step (iii) further comprises applying an additional force in the form of heat and/or positive or negative pressure (such as a vacuum).
   4. The method of paragraph 3, wherein the step of applying the additional force comprises heating the construct or a portion thereof (a) to a temperature within ±(5-20) ° C. of the Tg of the base polymer, wherein the base polymer has a Tg at or greater than room temperature, or (b) to a temperature in the range of 25-52° C., wherein the base polymer has a Tg lower than room temperature.
   5. The method of any one of paragraphs 1 to 4, wherein prior to step (iii), the construct is removed from the fabrication device and inserted into a second positioning device.
   6. The method of any one of paragraphs 1 to 5, further comprising prior to, simultaneous with or subsequent to step (i), mapping the time-dependent principal stress distribution of the model over the duration of the cycle of use.
   7. The method of any one of paragraphs 2 to 5, further comprising during step (ii) or subsequent to step (ii), spatially distributing a bulking polymer or a metal in a pattern that follows the regions of principal stress distribution, such that in regions of high stress during use, the construct is thicker than in regions of low stress during use, optionally wherein the bulking polymer is the same as the base polymer in the construct or wherein the bulking polymer is different than the base polymer.
   8. The method of any one of paragraphs 1 to 7, wherein during step (ii), the construct is fabricated via molding or thermoforming, optionally via compression molding, tension molding, or injection molding, and optionally wherein the feed to the mold comprises the base polymer and a plurality of fibers.
   9. The method of paragraph 8, wherein the fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.
   10. The method of any one of paragraphs 1 to 9, wherein the construct formed during step (ii) comprises one or more gripping regions, optionally further comprising subsequent to step (ii),
(iii) curing the construct, and then
(iv) applying an extension force to at least one of the gripping regions while the construct is under tension.
   11. The method of paragraph 10, wherein step (iv) further comprises heating the mold to (a) a temperature within ±(5-20) ° C. of the Tg of the base polymer, wherein the base polymer has a Tg at or greater than room temperature, or (b) to a temperature in the range of 25-52° C., wherein the base polymer has a Tg lower than room temperature.
   12. The method of paragraph 10 or 11, further comprising subsequent to step (iv), (v) subjecting the construct to a freeze-thaw temperature cycle.
   13. The method of any one of paragraphs 10 to 12, further comprising subsequent to step (iv), removing excess gripping regions from the construct.
   14. The method of any one of paragraphs 1 to 13, wherein the construct is formed from one or more base polymers, optionally with one or more metals selected from the group consisting of nitinol, cobalt chromium, and stainless steel, and wherein step (ii) comprises a thermal-mechanical processing, such as compression molding, injection molding, transfer molding, and/or extrusion molding.
   15. The method of any one of paragraphs 1 to 14, wherein the base polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(F-decalactone), silicones, thermoplastic elastomers, polyolefin and polydiene elastomers, poly(vinyl chloride), natural rubber, heparinized polymers, hydrogels, polypeptide elastomers, polysiloxane-urea elastomers, and polyurethanes (such as polyurethanes with a hard segment content and a mixed polyether/siloxane soft segment).
   16. The method of any one of paragraphs 7 to 15, wherein the bulking polymer is selected from the group consisting of crosslinked poly(styrene-isobutylenese-styrene) (xSIBS) or poly(styrene-isobutylene-styrene) (SIBS), polyurethanes such as Tecoflex, Tecothane, Elast-eon; copolymers of polypropylene (PP), polyacrylonitrile (PAN), polyethylene terephthalate (PET) with Polydimethylsiloxane (PDMS).
   17. A method for making constructs that are subjected to repeated cyclic loading in use, comprising:
(i) mapping the time-dependent principal stress distribution of a model of the construct over the duration of a cycle of use,
(ii) fabricating the construct, wherein the construct comprises a base polymer, and
(iii) spatially distributing a bulking polymer or metal in a pattern that follows the regions of principal stress distribution, such that in regions of high stress during use, the construct is thicker than in regions of low stress during use.
   18. The method of paragraph 17, wherein step (iii) occurs simultaneous with step (ii).
   19. The method of paragraph 17, wherein step (iii) occurs subsequent to step (ii).
   20. The method of any one of paragraphs 17 to 19, wherein following step (iii), when the construct is subjected to the repeated cyclic loading in use, the neutral axis of the construct shifts compared to its location if the construct was formed in the absence of step (iii).
   21. The method of any one of paragraphs 17 to 20, wherein during step (iii), a bulking polymer is applied, and wherein the bulking polymer is the same as the base polymer in the construct or wherein the bulking polymer is different than the base polymer.
   22. The method of paragraph 21, wherein the bulking polymer is a polymer that distributes under stress within the construct following repeated cycles of use, thereby reducing the stress at a given location compared to the stress at that same location in the absence of the bulking polymer.
   23. The method of paragraph 21, wherein the bulking polymer has a high Poisson ratio, optionally wherein the bulking polymer is a thermoplastic polymer, such as for example an elastomer.
   24. The method of any one of paragraphs 17 to 22, wherein the bulking polymer is selected from the group consisting of polyurethanes (PU), polypropylene (PP), polyacrylonitrile (PAN), polyethylene terephthalate (PET), and polyetheretherketone (PEEK).
   25. The method of any one of paragraphs 17 to 20, wherein during step (iii), a metal is applied, optionally wherein the metal is selected from the group consisting of gold, tantalum, platinum, palladium, lead, chromium, iron, nickel, or salts, composites, admixtures, blends or alloys thereof; optionally the metal is an alloy, such as stainless steel.
   26. The method of paragraph 25, wherein step (iii) occurs subsequent to step (ii), and wherein during step (iii) the metal is applied to the construct via physical vapor deposition (PVD), chemical vapor deposition (CVD) electroplating, electroless plating, thermal spray (TS), cold spray additive manufacturing, or slurry dip coating.
   27. A method for making constructs that are subjected to repeated cyclic loading in use, comprising:
(i) mapping the time-dependent principal stress distribution of a model of the construct over the duration of a cycle of use,
(ii) fabricating the construct, wherein the construct comprises a base polymer and a plurality of fibers, and
(iii) applying an extension force to one or more gripping regions on the surface of the construct, to orient the fibers in one or more directions.
   28. A method for making constructs that are subjected to repeated cyclic loading in use, comprising:
(i) mapping the time-dependent principal stress distribution of a model of the construct over the duration of a cycle of use,
(ii) fabricating the construct, wherein the construct comprises a base polymer and a plurality of fibers, and
(iii) applying a directional force by directional ultrasound or another non-contact force field to orient the fibers in one or more directions.
   29. The method of paragraph 27 or 28, wherein step (iii) occurs subsequent to step (ii).
   30. The method of any one of paragraphs 27 to 29, wherein during in step (ii), the construct is fabricated via molding or thermoforming, optionally via compression molding, tension molding, or injection molding.
   31. The method of any one of paragraphs 27 to 30, wherein the base polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(F-decalactone), silicones, thermoplastic elastomers, polyolefin and polydiene elastomers, poly(vinyl chloride), natural rubber, heparinized polymers, hydrogels, polypeptide elastomers, polysiloxane-urea elastomers, and polyurethanes (such as polyurethanes with a hard segment content and a mixed polyether/siloxane soft segment).
   32. The method of any one of paragraphs 27 to 31, wherein the fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.
   33. The method of any one of paragraphs 27 and 29 to 32, wherein step (iii) comprises applying an extension force to one or more gripping regions on the surface of the construct to orient the fibers in one or more directions.
   34. The method of any one of paragraphs 27 and 29 to 33, wherein subsequent to step (ii), the construct is cured prior to applying an extension force in step (iii).
   35. The method of any one of paragraphs 27 to 34, wherein during step (iii) the construct is heated to a sufficient temperature to make the polymer deformable, optionally wherein the base polymer is a thermoplastic, and the construct or relevant region thereof is heated to a temperature within ±(5-20) ° C. of the Tg of the base polymer, or wherein the base polymer is a thermoset polymer, and the construct or relevant region thereof is heated to a temperature in the range of 25-52° C.
   36. The method of any one of paragraphs 27 and 29 to 35, wherein during step (iii) an extension force is bi-axially applied to the construct or a portion thereof.
   37. The method of any one of paragraphs 27 to 36, wherein subsequent to step (iii), the construct is subjected to one or more freeze-thaw temperature cycles, sufficient to orient the fibers without significantly altering the base polymer structure.
   38. The method of any one of paragraphs 27 and 29 to 37, wherein after step (ii), the construct comprises one or more gripping regions on its surface, and wherein subsequent to step (iii), the gripping regions are removed from the construct.
   39. A polymeric construct as formed using the method of any one of paragraphs 1 to 38.
   40. A polymeric construct that is subjected to repeated cyclic loading in use, comprising a polymeric material and a plurality of fibers embedded therein, wherein the fibers are oriented in the direction(s) that correspond with the direction(s) of the application of the highest loads when in use.
   41. A polymeric construct that is subjected to repeated cyclic loading in use, comprising a polymeric material with a spatially localized bulking polymer or metal embedded therein.
   42. The polymeric construct of paragraph 40 or 41, wherein the polymeric material comprises a thermoset or a thermoplastic polymer.
   43. The polymeric construct of paragraph 41 or 42, wherein the bulking polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(F-decalactone), silicones, thermoplastic elastomers, polyolefin and polydieneelastomers, poly(vinyl chloride), natural rubber, heparinized polymers, hydrogels, polypeptide elastomers, Polysiloxane-urea elastomers, and polyurethanes.
   44. The polymeric construct of any one of paragraphs 40, 42, and 43, wherein the fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.

Exemplary constructs are illustrated in the figures which are described in the prophetic examples below.

### EXAMPLES

### Example 1: Polymeric Constructs with Spatially Distributed Thicknesses Corresponding to the Regions of Principal Stress Distribution when in Use

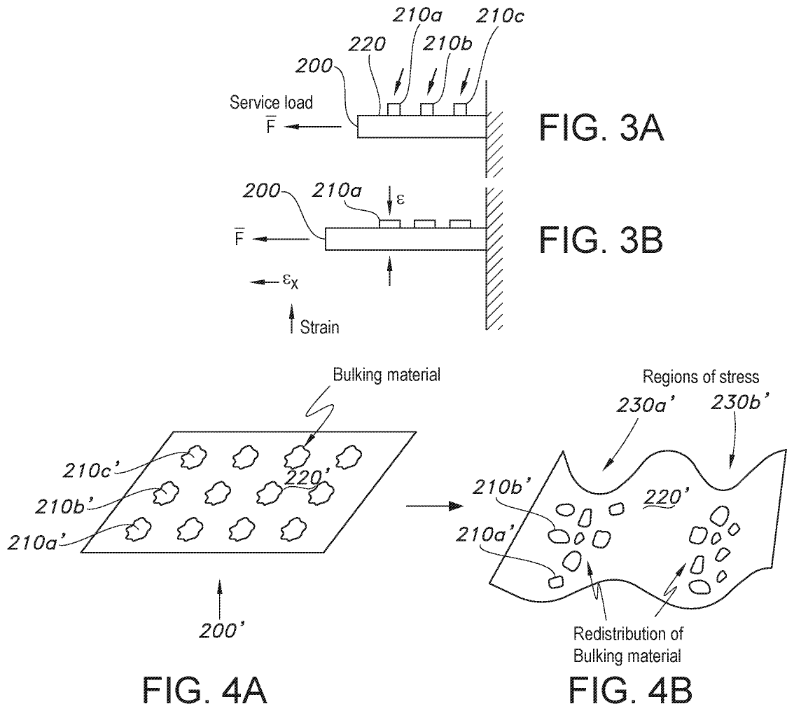

As shown in FIGS. 3A, 3B, 4A, 4B, 5A, and 5B, the construct can contain one or more bulking regions (210a, b, c) which are thicker than the surrounding area of the construct (compare height of surface 220 to height of bulking regions 210a, b, c). The bulking regions arranged in a pattern that follows the regions of principal stress distribution when the construct is used. For example, in regions of high stress 230a′ and 230 b′ during use, the construct is thicker than in regions of low stress during use (see e.g., FIG. 4B).

As shown in FIGS. 3A and 3B, the construct 200 has a surface 220 to which one or more bulking regions (210a, b, c) are attached or integrated therein. The bulking regions have a greater cross-sectional area than the construct in the surrounding regions. When an extension force F is applied to the end of the construct during a use cycle, the construct stretches (see FIG. 3B), thereby reducing the cross-sectional area at a given region, however, the bulking regions also stretch, thereby temporarily increasing the cross-sectional area in the region adjacent to the bulking region. By increasing the cross-sectional area in regions of high stress during use, the load experienced by this region is decreased, causing less fatigue in the construct over time.

Additionally, as shown in FIGS. 4A and 4B, as stress is applied to different portions of the construct during use, the bulking material in the bulking regions can redistribute from a first position (see bulking regions 210a′ and 210b′ in FIG. 4A) to a second position (see bulking regions 210a′ and 210b′ in FIG. 4B). Optionally, the bulking material or a portion thereof returns to its original position when the construct is not subjected to loading. In this example, during a use cycle, the construct undergoes bending stress-strain, created regions of high stress 230a′ and 230b′, and the extra bulking polymer or metal distributes to the high stress regions of the construct during use and can shift the neutral axis.

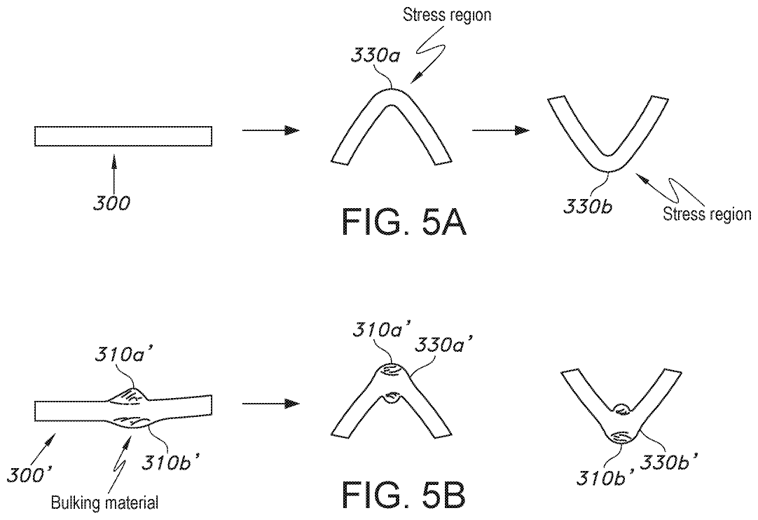

As shown in FIGS. 5A and 5B, the regions of high stress 330a and 330b in a construct 300, in this case regions where bending occurs, can be modified to contain a bulking polymer or metal, which forms a bulking region. As shown in FIG. 5B, the regions of high stress 330a′ and 330b′ with the bulking regions 310a′ and 310b′ attached thereto are thicker than the surrounding regions of the construct 300′. As there is only tensile or comprehensive stress during use in these high stress regions, the extra bulking polymer or metal, increases the cross-sectional thickness of the high-stress regions 330a′ and 330b′ thereby reducing the stress of in these regions during a typical use cycle of the construct.

In these embodiments, the spatially positioned materials are at greater bulk, resulting in an increased thickness or width. Thus, including a bulking material at a region of high stress, increases the volume of material at the region of high stress and thereby distributes cyclic use stress. Alternatively, including a bulking material at a region of high stress, increases the density of the material at the regions of high stress, and thereby mitigate the effects of cyclic use stress, i.e., wear in the regions of high stress.

The bulking material may be the same as the base material in the construct. Optionally, the bulking material is different from the base material in terms of molecular weight, crystallinity, and/or chemical structure. Optionally, the bulking material is a composite including the base polymer of the construct. The use of the same material or a composite containing the base polymer of the construct results in a smooth transition from the region of the construct that surrounds the bulking region. Providing a smooth transition from one region to the next, rather than a sharp discontinuity, prevents or reduces the likelihood of the bulking region(s) creating a fracture point in the construct.

### Example 2: Polymeric Constructs with Fibers Oriented Therein

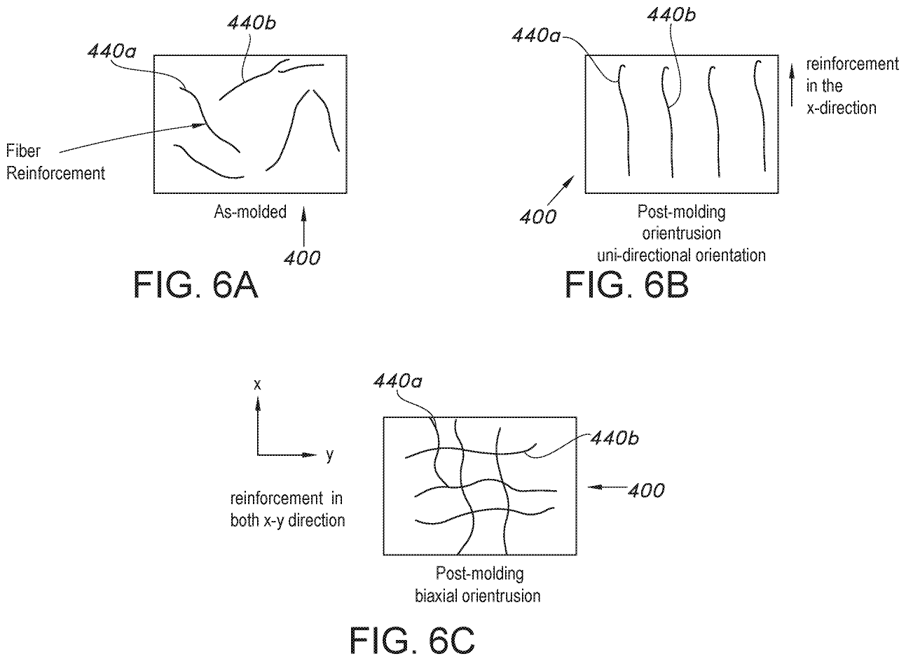

As shown in FIGS. 6A-6C, the construct can contain a plurality of fibers embedded in the polymeric material. FIG. 6A shows a typical random positioning of a plurality of fibers in the construct post fabrication of the construct (400).

FIG. 6B shows how a plurality of fibers (see fibers 440a and 440b) can be oriented post-fabrication in a uni-directional orientation. To obtain this configuration, a force is applied to the construct in a single direction (x-direction).

FIG. 6C shows how the fibers in the construct can be oriented in two different directions (i.e. x-y directions). To obtain this configuration, after forming the construct, the construct is subjected to bi-axial forces. As shown in FIG. 6C, some fibers are oriented in the x-direction (see fiber 440a), while others are oriented along the y-direction (see fiber 440b). The resulting construct is stronger and able to withstand repeated stresses compared to the same construct without fibers or even the same construct with the same concentration of fibers, but where the fibers are not oriented in one or more, optionally at least two directions.

Optionally, the force is applied in a direction or directions that correspond with the direction(s) of the application of the highest loads when in use.

It is understood that the disclosed methods and constructs are not limited to the particular methodology, protocols, and reagents described as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise.

Throughout the description and claims of this specification, the word “comprise” and variations of the word, such as “comprising” and “comprises,” means “including but not limited to,” and is not intended to exclude, for example, other additives, components, integers or steps.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. It should be understood that all of the individual values and sub-ranges of values contained within an explicitly disclosed range are also specifically contemplated and should be considered disclosed unless the context specifically indicates otherwise. Finally, it should be understood that all ranges refer both to the recited range as a range and as a collection of individual numbers from and including the first endpoint to and including the second endpoint. In the latter case, it should be understood that any of the individual numbers can be selected as one form of the quantity, value, or feature to which the range refers. In this way, a range describes a set of numbers or values from and including the first endpoint to and including the second endpoint from which a single member of the set (i.e. a single number) can be selected as the quantity, value, or feature to which the range refers. The foregoing applies regardless of whether in particular cases some or all of these embodiments are explicitly disclosed.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Although the description of materials, compositions, components, steps, techniques, etc. may include numerous options and alternatives, this should not be construed as, and is not an admission that, such options and alternatives are equivalent to each other or, in particular, are obvious alternatives.

Those skilled in the art will recognize, or be able to ascertain using no more than routine experimentation, many equivalents to the specific embodiments of the method and compositions described herein. Such equivalents are intended to be encompassed by the following claims.

1. A method for making constructs that are subjected to repeated cyclic loading in use, comprising:
(i) determining the mid-point conformation of the construct when subjected to repeated loading over a cycle of use,
(ii) fabricating the construct in the mid-point conformation, optionally wherein the construct comprises a base polymer, and
(iii) subsequent to step (ii), repositioning the construct into a second conformation that is different from the mid-point conformation, optionally wherein the second conformation is the deployment conformation.

2. The method of claim 1, wherein step (i) comprises modeling the construct and subjecting the model to a load through the range of motion of the construct or a portion thereof during one or more use cycles, and estimating the spatially dependent stresses in at least one region of the construct, optionally throughout the construct,
optionally comprising during step (ii) or subsequent to step (ii), spatially distributing the bulking polymer or a metal in a pattern that follows the regions of principal stress distribution, such that in regions of high stress during use, the construct is thicker than in regions of low stress during use, and/or
optionally wherein the bulking polymer is the same as the base polymer in the construct or wherein the bulking polymer is different than the base polymer.

3. The method of claim 1, wherein step (iii) further comprises applying an additional force in the form of heat and/or positive or negative pressure (such as a vacuum),
optionally wherein the step of applying the additional force comprises heating the construct or a portion thereof (a) to a temperature within ±(5-20) ° C. of the Tg of the base polymer, wherein the base polymer has a Tg at or greater than room temperature, or (b) to a temperature in the range of 25-52° C., wherein the base polymer has a Tg lower than room temperature.

4. (canceled)

5. The method of claim 1, wherein prior to step (iii), the construct is removed from the fabrication device and inserted into a second positioning device,
optionally comprising prior to, simultaneous with or subsequent to step (i), mapping the time-dependent principal stress distribution of the model over the duration of the cycle of use.

6-7. (canceled)

8. The method of claim 1, wherein during step (ii), the construct is fabricated via molding or thermoforming, optionally via compression molding, tension molding, or injection molding, and optionally wherein the feed to the mold comprises the base polymer and a plurality of fibers,
optionally wherein the plurality of fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.

9. (canceled)

10. The method of claim 1, wherein the construct formed during step (ii) comprises one or more gripping regions, optionally further comprising subsequent to step (ii),
(iii) curing the construct, and then
(iv) applying an extension force to at least one of the gripping regions while the construct is under tension,
optionally wherein step (iv) further comprises heating the mold to (a) a temperature within ±(5-20) ° C. of the Tg of the base polymer, wherein the base polymer has a Tg at or greater than room temperature, or (b) to a temperature in the range of 25-52° C., wherein the base polymer has a Tg lower than room temperature,
optionally further comprising subsequent to step (iv), (v) subjecting the construct to a freeze-thaw temperature cycle, and/or
optionally further comprising subsequent to step (iv), removing excess gripping regions from the construct.

11-13. (canceled)

14. The method of claim 1, wherein the construct is formed from one or more base polymers, optionally with one or more metals selected from the group consisting of nitinol, cobalt chromium, and stainless steel, and
wherein step (ii) comprises a thermal-mechanical processing, such as compression molding, injection molding, transfer molding, and/or extrusion molding,
optionally wherein the base polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(ε-decalactone), silicones, thermoplastic elastomers, polyolefin and polydiene elastomers, poly(vinyl chloride), natural rubber, heparinized polymers, hydrogels, polypeptide elastomers, polysiloxane-urea elastomers, and polyurethanes (such as polyurethanes with a hard segment content and a mixed polyether/siloxane soft segment).

15. (canceled)

16. The method of claim 2, wherein the bulking polymer is selected from the group consisting of crosslinked poly(styrene-isobutylenese-styrene) (xSIBS) or poly(styrene-isobutylene-styrene) (SIBS), polyurethanes such as Tecoflex, Tecothane, Elast-eon; copolymers of polypropylene (PP), polyacrylonitrile (PAN), polyethylene terephthalate (PET) with Polydimethylsiloxane (PDMS).

17. A method for making constructs that are subjected to repeated cyclic loading in use, comprising:
(i) mapping the time-dependent principal stress distribution of a model of the construct over the duration of a cycle of use,
(ii) fabricating the construct, wherein the construct comprises a base polymer, optionally wherein the construct further comprises a plurality of fibers, and
(iii) spatially distributing a bulking polymer or metal in a pattern that follows the regions of principal stress distribution, such that in regions of high stress during use, the construct is thicker than in regions of low stress during use, or
(iii′) wherein when the construct comprises a plurality of fibers, applying an extension force to one or more gripping regions on the surface of the construct, to orient the fibers in one or more directions, or
(iii″) wherein when the construct comprises a plurality of fibers, applying a directional force by directional ultrasound or another non-contact force field to orient the fibers in one or more directions.

18. The method of claim 17, wherein step (iii), (iii′), or (iii″) occurs subsequent to step (ii), or wherein step (iii) occurs simultaneous with step (ii),
optionally wherein following step (iii), when the construct is subjected to the repeated cyclic loading in use, the neutral axis of the construct shifts compared to its location if the construct was formed in the absence of step (iii).

19-20. (canceled)

21. The method of claim 17, wherein during step (iii), the bulking polymer is applied, and wherein the bulking polymer is the same as the base polymer in the construct or wherein the bulking polymer is different than the base polymer,
optionally wherein the bulking polymer is a polymer that distributes under stress within the construct following repeated cycles of use, thereby reducing the stress at a given location compared to the stress at that same location in the absence of the bulking polymer,
optionally wherein the bulking polymer has a high Poisson ratio, optionally wherein the bulking polymer is a thermoplastic polymer, such as for example an elastomer, and/or
optionally wherein the bulking polymer is selected from the group consisting of polyurethanes (PU), polypropylene (PP), polyacrylonitrile (PAN), polyethylene terephthalate (PET), and polyetheretherketone (PEEK).

22-24. (canceled)

25. The method of claim 17, wherein during step (iii), a metal is applied, optionally wherein the metal is selected from the group consisting of gold, tantalum, platinum, palladium, lead, chromium, iron, nickel, or salts, composites, admixtures, blends or alloys thereof; optionally the metal is an alloy, such as stainless steel,
optionally step (iii) occurs subsequent to step (ii), and wherein during step (iii) the metal is applied to the construct via physical vapor deposition (PVD), chemical vapor deposition (CVD) electroplating, electroless plating, thermal spray (TS), cold spray additive manufacturing, or slurry dip coating.

26-29. (canceled)

30. The method of claim 17, wherein the construct comprises a plurality of fibers, and wherein during in step (ii), the construct is fabricated via molding or thermoforming, optionally via compression molding, tension molding, or injection molding.

31. The method of claim 17, wherein the construct comprises a plurality of fibers, and wherein the base polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(F-decalactone), silicones, thermoplastic elastomers, polyolefin and polydiene elastomers, poly(vinyl chloride), natural rubber, heparinized polymers, hydrogels, polypeptide elastomers, polysiloxane-urea elastomers, and polyurethanes (such as polyurethanes with a hard segment content and a mixed polyether/siloxane soft segment),
optionally wherein the fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.

32. (canceled)

33. The method of claim 17, wherein the construct comprises a plurality of fibers, and wherein step iii′) comprises applying an extension force to one or more gripping regions on the surface of the construct to orient the fibers in one or more directions, or
wherein during step (iii′) or (iii″) the construct is heated to a sufficient temperature to make the polymer deformable,
optionally wherein the base polymer is a thermoplastic, and the construct or relevant region thereof is heated to a temperature within ±(5-20) ° C. of the Tg of the base polymer, or
wherein the base polymer is a thermoset polymer, and the construct or relevant region thereof is heated to a temperature in the range of 25-52° C.

34. The method of claim 17, wherein subsequent to step (ii), the construct is cured prior to applying an extension force in step (iii′).

35. (canceled)

36. The method of claim 17 when the construct comprises a plurality of fibers, and wherein during step iii′) an extension force is bi-axially applied to the construct or a portion thereof,
wherein subsequent to step (iii′) or (iii″), the construct is subjected to one or more freeze-thaw temperature cycles, sufficient to orient the fibers without significantly altering the base polymer structure, and/or
wherein after step (ii), the construct comprises one or more gripping regions on its surface, and wherein subsequent to step (iii′), the gripping regions are removed from the construct.

37-45. (canceled)

46. A polymeric construct that is subjected to repeated cyclic loading in use, comprising a polymeric material and a plurality of fibers embedded therein, wherein the fibers are oriented in the direction(s) that correspond with the direction(s) of the application of the highest loads when in use, or
comprising a polymeric material with a spatially localized bulking polymer or metal embedded therein,
optionally, wherein the polymeric material comprises a thermoset or a thermoplastic polymer.

47-48. (canceled)

49. The polymeric construct of claim 46, wherein the bulking polymer is selected from the group consisting of polysulfone, crosslinked poly(styrene-isobutylenese-styrene) (xSIBS) or poly(styrene-isobutylene-styrene) (SIBS), polymyrcene, polymenthide, and poly(ε-decalactone), silicones, thermoplastic elastomers, polyolefin and polydieneelastomers, poly(vinyl chloride), natural rubber, heparinized polymers, hydrogels, polypeptide elastomers, Polysiloxane-urea elastomers, and polyurethanes.

50. The polymeric construct of claim 46, wherein the fibers are selected from the group consisting of cellulose fibers, polyvinyl acetate (PVAc) fibers, Tecothane® (aromatic polyether-based thermoplastic polyurethanes (TPUs)) fibers, polypropylene (PP) fibers, polyacrylonitrile (PAN) fibers, polyethylene terephthalate (PET) fibers, polyetheretherketone (PEEK) fibers, carbon fibers, and glass fibers, or a combination thereof.
